(19) United States
(12) Patent Application Publication
(10) Pub. No.: US 2002/0051244 A1
(43) Pub. Date: May 2, 2002

(54) Image processor

(76) Inventors: Eiichi Hayashi, Ohmiya-shi (JP); Yuichi Kawanabe, Ohmiya-shi (JP); Hideyuki Sekiguchi, Ibaraki-ken (JP); Akira Yasuda, Ibaraki-ken (JP)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/756,434

(22) Filed: Jan. 8, 2001

(30) Foreign Application Priority Data
Jan. 13, 2000 (JP) 2000-004330

(51) Int. Cl. H04N 1/04

(52) U.S. Cl. 358/475

(57) ABSTRACT

An image processor has a light source lamp for illuminating an original when scanning the original. The lamp can be attached to and detached from lamp brackets, and the lamp brackets can be attached to and detached from a carriage which is moved for the scanning operation, whereby the light source lamp can be attached to and detached from the carriage without having to disconnect the carriage from wires.

### BACKGROUND OF THE INVENTION

1. Field of the Invention

The present invention relates to an image processor for illuminating an original with light from a light source lamp so as to read the image information from the original through reflected light therefrom. More particularly, the present invention relates to an image processor, which is designed so as to facilitate the replacement of the light source lamp.

2. Description of the Related Art

An image processor of a stationary original type performs a scanning operation for obtaining the image information line by line by moving the light source lamp with respect to an original, which is placed, on a platen glass. FIG. 15 is a perspective view generally illustrating the structure of an image processor of this type. The image processor 1 comprises a casing 2 which includes a support plate 2b in the form of a stepped portion on the inner side of a longitudinal wall 2a of the casing 2. A full rate carriage 3 and a half rate carriage 4 are placed on the support plate 2b so that the carriages 3 and 4 are moved along the longitudinal direction of the casing 2 while being guided by the support plate 2b. A platen glass (not shown) is attached to the upper surface of the casing 2, and an original is placed on the platen glass. A fluorescent lamp 5 as a light source lamp is mounted on the full rate carriage 3, and the original is illuminated by the fluorescent lamp 5. An imaging lens 6 and a photoelectric conversion device 7 such as a CCD (charge coupled device) are provided in appropriate positions on a bottom plate 2c of the casing 2.

The full rate carriage 3 is conventionally provided with a first reflector (not shown), and the half rate carriage 4 is provided with a second reflector (not shown) and a third reflector (not shown). The light from the fluorescent lamp 5 is reflected by the original, and then by the first, second and third reflectors in this order. Then, the light passes through the imaging lens 6 so as to be incident upon the photoelectric conversion device 7. Thus, the first, second and third reflectors together form an optical path from the original to the photoelectric conversion device 7. In order to obtain the image information of the original, it is necessary to illuminate the entire area of the original. Accordingly, the full rate carriage 3 is provided so that the full rate carriage 3 can be moved across the entire area of the platen glass. The optical path length to the photoelectric conversion device 7 needs to be constant in spite of the movement of the full rate carriage 3. Therefore, the half rate carriage 4 is moved in synchronism with the full rate carriage 3 with the amount of movement thereof being about 1/2 of that of the full rate carriage 3 so as to keep the optical path length constant.

In the conventional image processor described above, the fluorescent lamp 5 is incorporated while being secured, for example, by being screwed onto the full rate carriage 3 directly or via a bracket. This leads to several problems. When replacing the fluorescent lamp 5, the platen glass is removed and, if wires connected to the full rate carriage 3 for driving the full rate carriage 3 interfere with the replacement, the full rate carriage 3 needs to be disconnected from the wires, before the fluorescent lamp 5 can be removed from the full rate carriage 3. Then, the full rate carriage 3 to which a new fluorescent lamp 5 has been attached is installed in a predetermined position while connecting the full rate carriage 3 to the wires. Then, the platen glass is attached to the apparatus, thereby completing the replacement process. Therefore, in some cases, it is necessary to once disconnect the wires from the full rate carriage 3 and then to connect the full rate carriage 3 to the wires again, thereby making the replacement process troublesome. Moreover, when installing the full rate carriage 3 while connecting the full rate carriage 3 to the wires, it is necessary to adjust the position of the full rate carriage 3. This adjustment process is also troublesome.

### SUMMARY OF THE INVENTION

In view of the foregoing, the present invention has an object of providing an image processor which is designed to facilitate the replacement of a light source lamp such as a fluorescent lamp for illuminating an original.

As technical means for achieving the object, the present invention provides an image processor for obtaining image information of an original by scanning the original while successively changing a position of illumination by moving a light source lamp mounted on a carriage with respect to the original, wherein the light source lamp is detachably attached to a lamp bracket; and the lamp bracket is detachably attached to the carriage which is provided in a casing.

In order to replace the light source lamp with a new light source lamp, the platen glass is removed to expose the carriage. Then, the light source lamp and lamp bracket are detached from the carriage, and the light source lamp is subsequently detached from the lamp bracket. The new light source lamp is attached to the lamp bracket, the lamp bracket is attached to the carriage, and then the platen glass is attached to the casing. Thus, the replacement of the light source lamp can be performed without disconnecting the carriage from wires, which are provided for driving the carriage.

In the image processor of the present invention, the carriage can be moved to a replacement position which is beyond a range required for scanning the original; a replacement opening is provided in a portion of the casing which faces the replacement position; and the lamp bracket can be attached to and detached from the carriage via the replacement opening.

In order to replace the light source lamp with a new light source lamp, the carriage is moved to a position aligned with the replacement opening. Thus, the carriage and the light source lamp are exposed through the replacement opening, and the light source lamp can be replaced with a new light source lamp. Preferably, the replacement opening is closed by a lid, or the like, during normal operations. Although it is necessary to remove the lid when replacing the light source lamp, the attachment/detachment of the lid is easier than the attachment/detachment of the platen glass. Preferably, a stopper, or the like, is provided for limiting the moving range of the carriage so as to prevent the carriage from moving to the replacement position except when replacing the light source lamp. Preferably, when replacing the light source lamp, the stopper is released to allow the carriage to move to the replacement position.

In the image processor of this invention, the lamp bracket can be attached to and detached from the carriage by an operation from above.

As long as the lamp bracket can be attached to and detached from the carriage within the casing, the direction of the attachment/detachment of the lamp bracket may be any direction. However, the replacement of the light source lamp can be performed more easily when the attachment/detachment can be performed by an operation from above. Particularly, in a structure where the replacement process is performed through the replacement opening, it is preferred that the attachment/detachment can be performed by an operation from above because it is then possible to minimize the size of the replacement opening.

In the image processor of the present invention, attachment/detachment of a connector of a cable which is connected to the light source lamp can be performed by an operation from above the carriage.

When replacing a light source lamp, it is necessary to disconnect the light source lamp from the inverter. If the connector used for connecting the light source lamp to the inverter can be attached to and detached from the inverter by an operation from above the carriage, the replacement process is even more convenient.

The nature, principle, and utility of the invention will become more apparent from the following detailed description when read in conjunction with the accompanying drawings in which like parts are designated by like reference numerals or characters.

### BRIEF DESCRIPTION OF THE DRAWINGS

FIG. 1 is a plan view illustrating a full rate carriage provided in an image processor according to the present invention;

FIG. 2 is a left-side view illustrating the full rate carriage provided in the image processor according to the present invention;

FIG. 3 is a right-side view illustrating the full rate carriage provided in the image processor according to the present invention;

FIG. 4 is a front view illustrating the full rate carriage provided in the image processor according to the present invention;

FIG. 5 is a plan view illustrating a lamp bracket used in the image processor according to the present invention;

FIG. 6 is a left-side view illustrating the lamp bracket for use in the image processor according to the present invention;

FIG. 7 is a front view illustrating the lamp bracket for use in the image processor according to the present invention;

FIG. 8 is a plan view illustrating the lamp bracket for use in the image processor according to the present invention, where the lamp bracket is attached to a fluorescent lamp;

FIG. 9 is a left-side view illustrating the lamp bracket for use in the image processor according to the present invention, where the lamp bracket is attached to a fluorescent lamp;

FIG. 10 is a front view illustrating the lamp bracket for use in the image processor according to the present invention, where the lamp bracket is attached to a fluorescent lamp;

FIG. 11 is a plan view illustrating the lamp bracket for use in the image processor according to the present invention, where the lamp bracket is attached to the full rate carriage, and the figure illustrates a portion of FIG. 1 in an enlarged view while omitting the rest of FIG. 1;

FIG. 12 is a left-side view illustrating the lamp bracket for use in the image processor according to the present invention, where the lamp bracket is attached to the fall rate carriage, and the figure illustrates a portion of FIG. 2 in an enlarged view while omitting the rest of FIG. 2;

FIG. 13 is a front view illustrating the lamp bracket for use in the image processor according to the present invention, where the lamp bracket is attached to the full rate carriage, and the figure illustrates a portion of FIG. 4 in an enlarged view while omitting the rest of FIG. 4;

FIG. 14 is a perspective view generally illustrating the image processor according to the present invention; and

FIG. 15 is a perspective view generally illustrating the structure of an image processor.

### DETAILED DESCRIPTION OF THE EMBODIMENTS

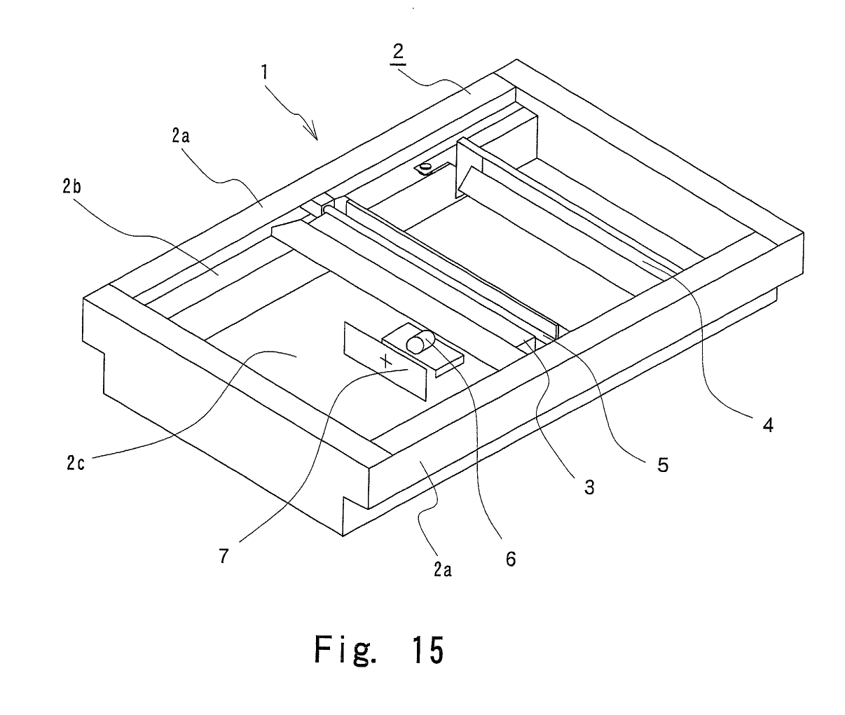

An image processor according to the present invention will now be specifically described based on a preferred embodiment thereof illustrated in the figures. The structure of the image processor will be described while using the same reference numerals as used in FIG. 15 for those elements which are already illustrated in FIG. 15.

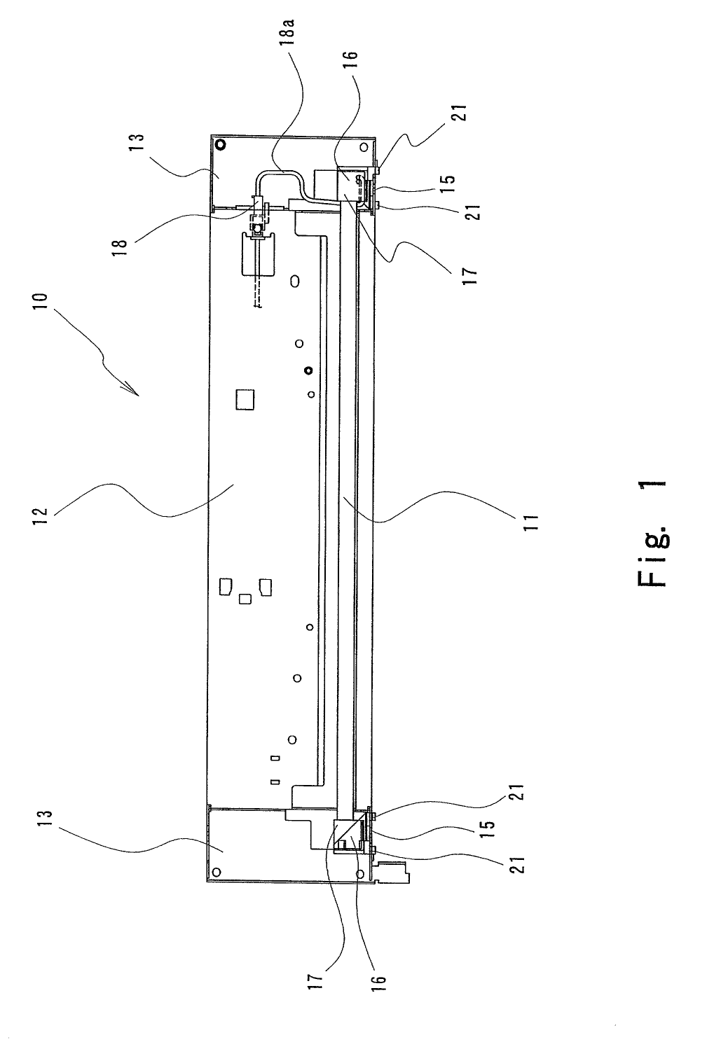

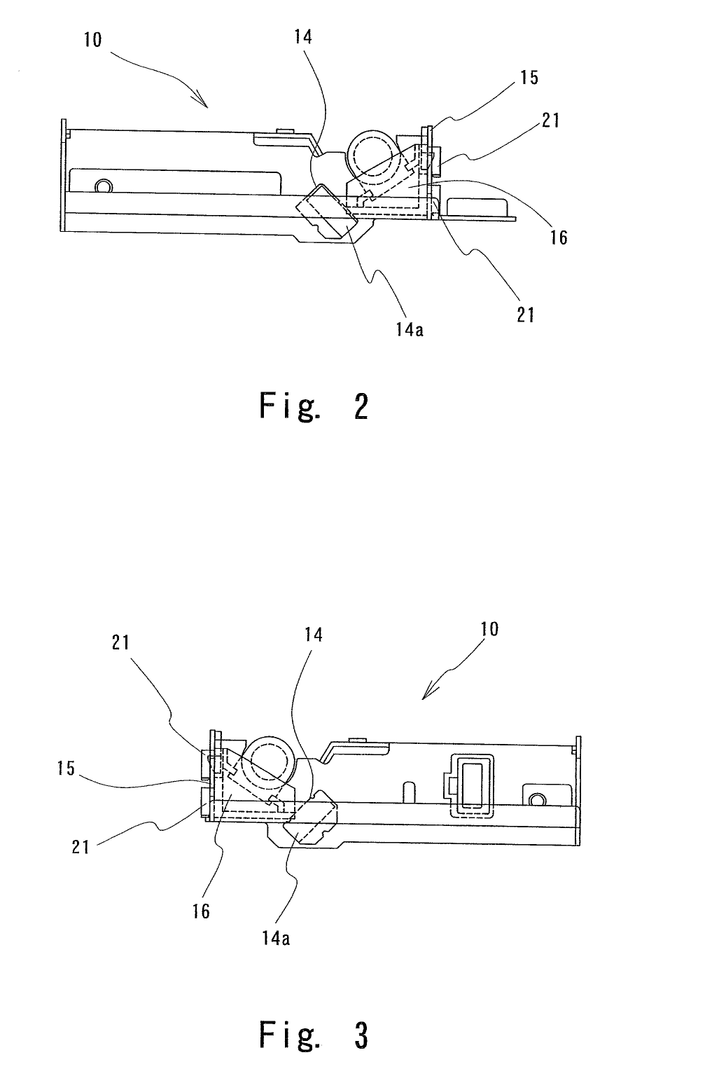

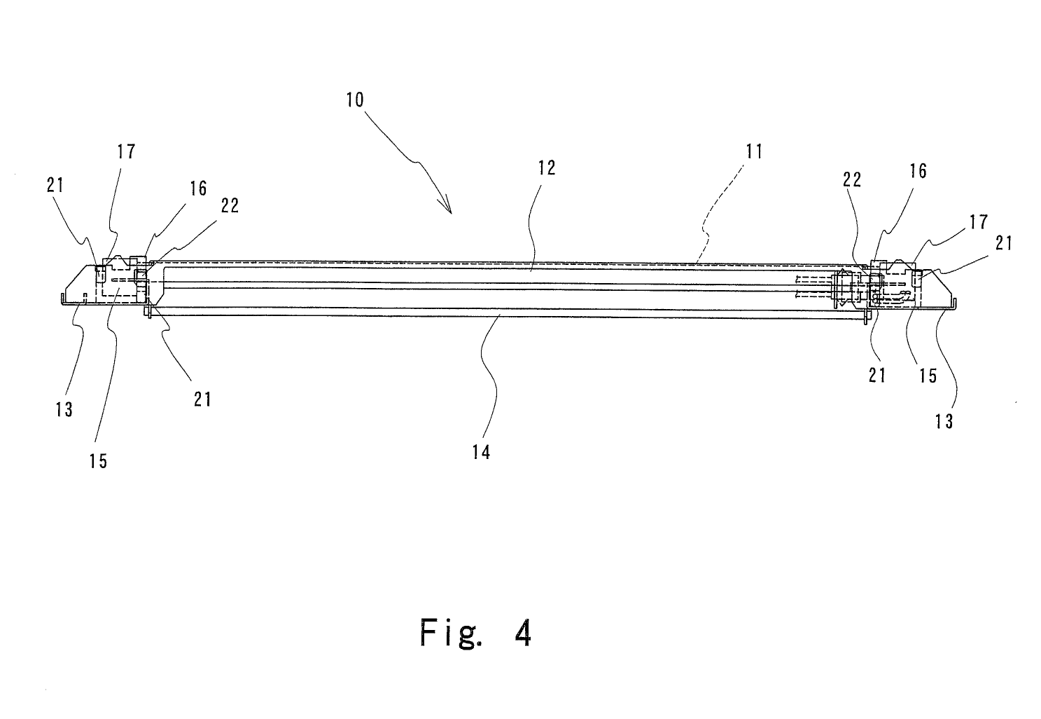

FIG. 1 to FIG. 4 illustrate a full rate carriage 10, wherein FIG. 1 is a plan view, FIG. 2 is a left-side view, FIG. 3 is a right-side view, and FIG. 4 is a front view. The full rate carriage 10 includes a carriage portion 12 on which a fluorescent lamp 11 as a light source lamp is mounted, and support portions 13 which are provided respectively on the opposite sides of the carriage portion 12 and placed on the support plate portion 2b of the casing 2 (FIG. 15). In the carriage portion 12, a first reflector 14 for reflecting the reflected light from an original toward a half rate carriage (not shown) is attached to a reflector attachment 14a. The fluorescent lamp 11 is attached to a pair of lamp brackets 16 each of which is detachably attached to a front wall 15 of the full rate carriage 10 extending in a direction perpendicular to the scanning direction of the full rate carriage 10 which is provided in the support 13. The fluorescent lamp 11 is capped with and held by sockets 17 at the opposite ends thereof. The sockets 17 can be attached to and detached from the lamp brackets 16. A cable 18a (FIG. 1) is connected to one end of the fluorescent lamp 11 for connecting the fluorescent lamp 11 to an inverter, which is mounted on the full rate carriage 10. The fluorescent lamp 11 can be attached to and detached from the inverter by an operation from above the full rate carriage 10 via a connector 18 which is connected to the distal end of the cable 18a.

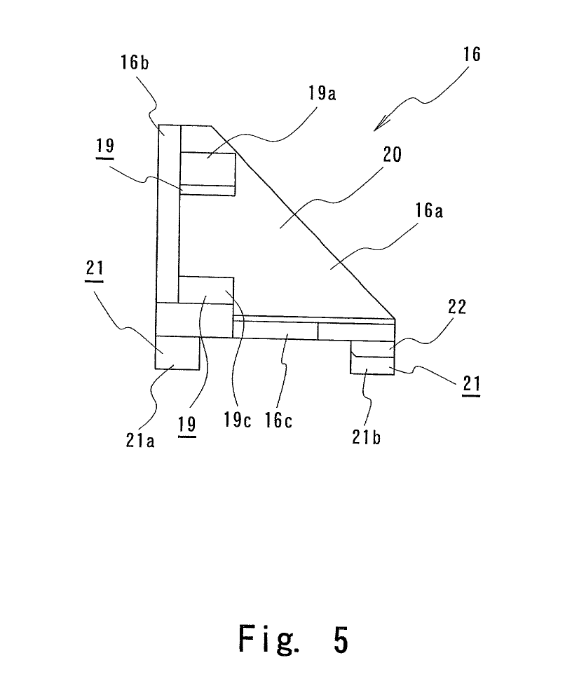

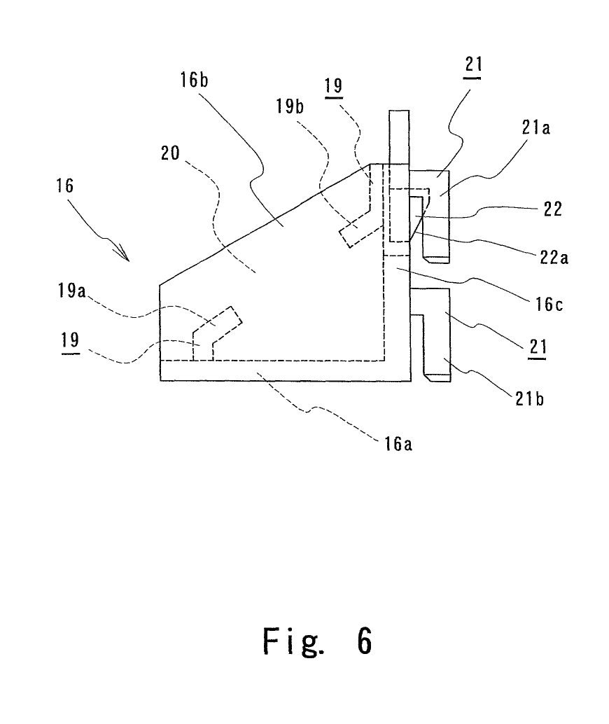

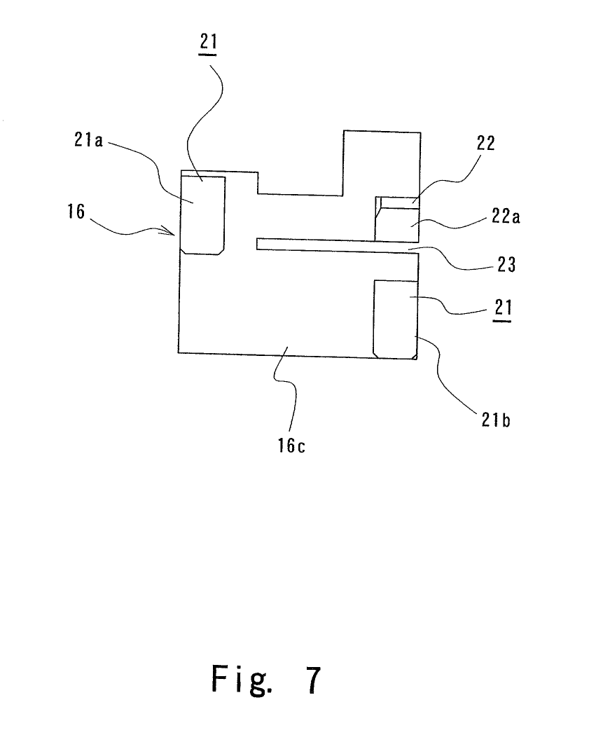

FIG. 5 to FIG. 7 illustrate the lamp bracket 16, wherein FIG. 5 is a plan view, FIG. 6 is a left-side view, and FIG. 7 is a front view. The lamp bracket 16 includes a generally trapezoidal bottom plate 16a, a generally trapezoidal side plate 16b and a front plate 16c which are attached to one another so as to be orthogonal with respect to one another. In other words, the lamp bracket 16 is a combination of three planes, i.e., the bottom plate 16a, the side plate 16b and the front plate 16c, with the other surfaces thereof being open. A pair of holding tongue pieces 19 for holding the sockets 17 of the fluorescent lamp 11 are provided on the inner surface of the side plate 16b and the inner surface of the front plate 16c, respectively. As illustrated in FIG. 5 and FIG. 6, the holding tongue pieces 19 are provided with tongue piece portions 19a and 19b, respectively, which are suitably inclined with respect to the bottom plate 16a and the front plate 16c, respectively. The tongue piece portions 19a and 19b face each other collinearly with each other, while being suitably spaced apart from each other with a gap 20 between the respective tips thereof. The tongue piece portions 19a and 19b are provided to be orthogonal to the side plate 16b. Each socket 17 is provided with holding groove portions 17a (shown in FIG. 9) to which the tongue piece portions 19a and 19b are inserted as will be described later.

A pair of stop tongue pieces 21 are provided on the outer surface of the front plate 16c. As illustrated in FIG. 6, each stop tongue piece 21 is generally L-shaped with the longer leg portion thereof pointing downwardly. The stop tongue pieces 21 are referred to as an upper tongue piece 21a and a lower tongue piece 21b, respectively. As illustrated in FIG. 7, a flexible tongue piece 22 is provided to protrude from the front plate 16c in a position above the lower tongue piece 21b. The surface of a lower portion of the flexible tongue piece 22 is an inclined surface 22a facing down, and the surface of an upper portion of the flexible tongue piece 22 is a generally horizontal surface. A slit 23 of a suitable length is provided under the flexible tongue piece 22 to extend from a side edge of the front plate 16c along a generally horizontal direction so that the flexible tongue piece 22 has suitable flexibility.

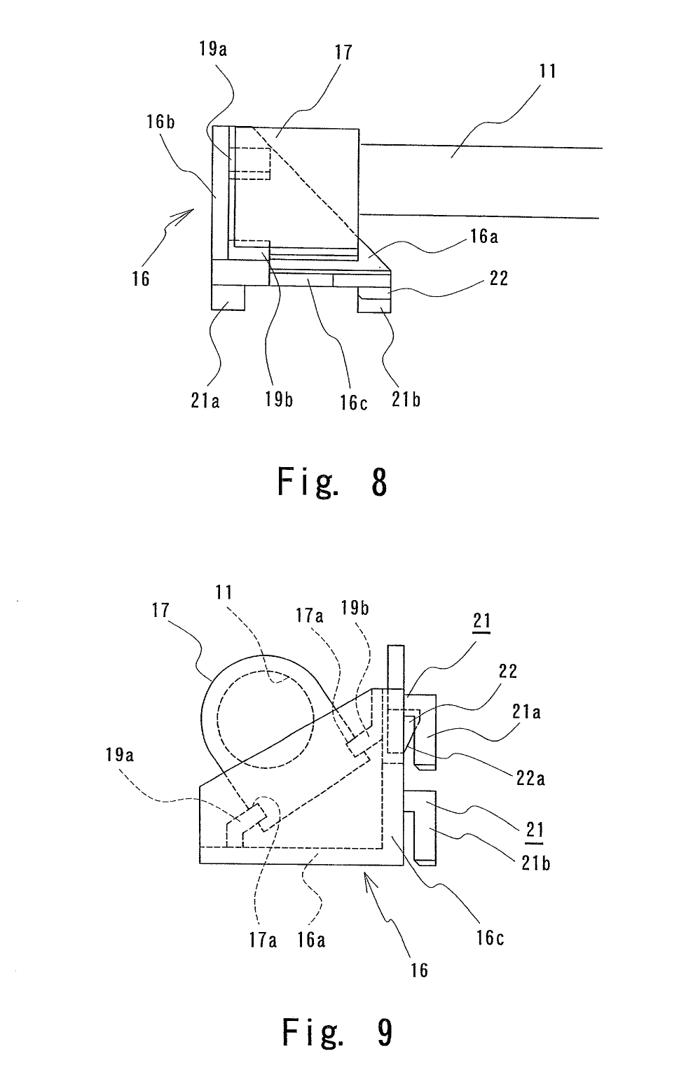

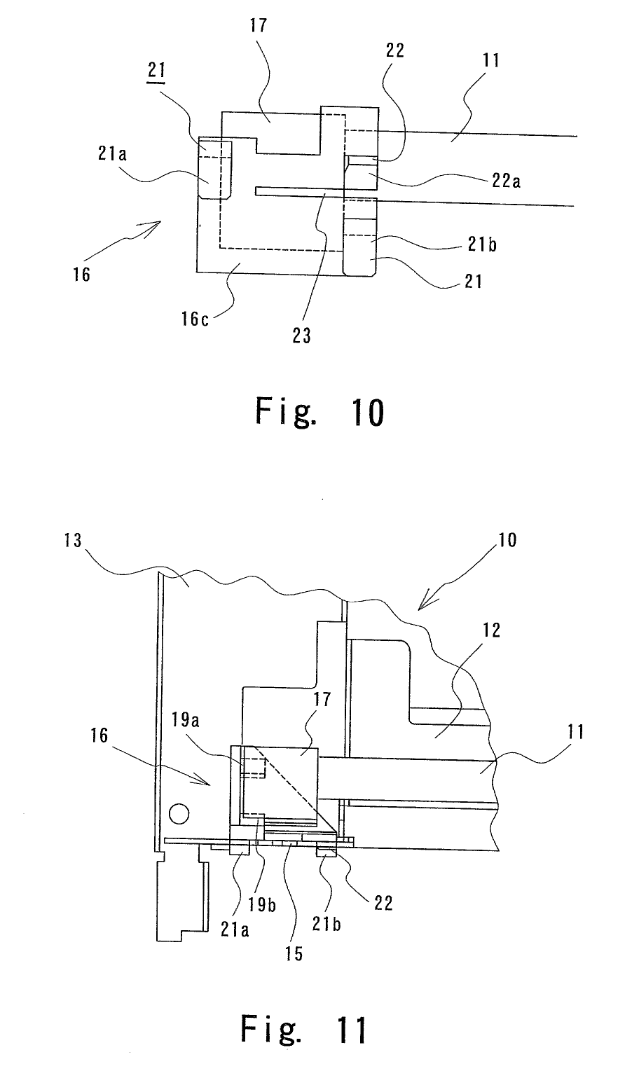

FIG. 8 to FIG. 10 illustrates the lamp bracket 16 being attached to the fluorescent lamp 11. As illustrated in FIG. 9, the sockets 17 on the opposite ends of the fluorescent lamp 11 each have a generally tunnel shape, with the fluorescent lamp 11 being held in the center of the arc portion thereof. The holding groove portions 17a are provided along the linear portion of the tunnel shape.

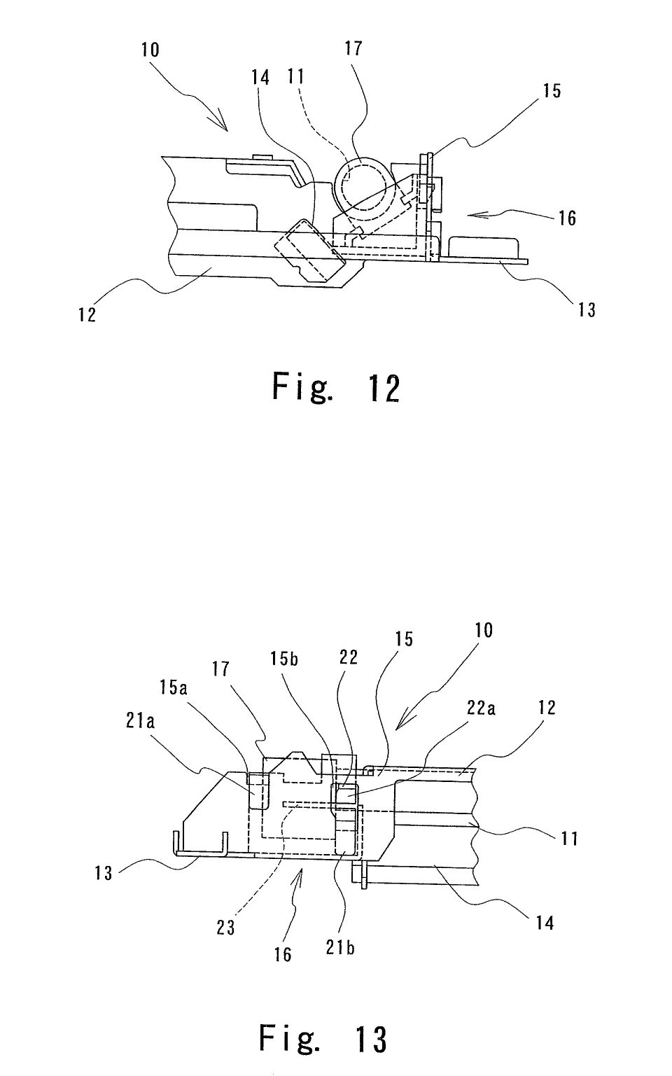

Each of FIG. 11 to FIG. 13 is an enlarged view illustrating a portion of the full rate carriage 10 for holding the fluorescent lamp 11. As illustrated in FIG. 13, an outside portion of the front wall 15 facing the support 13 includes an upper slit 15a extending downwardly from the upper edge thereof. A inside portion of the front wall 15 includes a lower opening 15b provided generally in the middle portion of the front wall 15. The upper tongue piece 21a of the lamp bracket 16 is engaged with the upper slit portion 15a, and the lower tongue piece 21b and the flexible tongue piece 22 of the lamp bracket 16 are engaged with the lower opening 15b. The present embodiment according to the present invention is designed so that these engagements can be made by easily inserting the lamp brackets 16 onto the full rate carriage 10 from above, and the engagements can be released by easily pulling up the lamp brackets 16 from the full rate carriage 10.

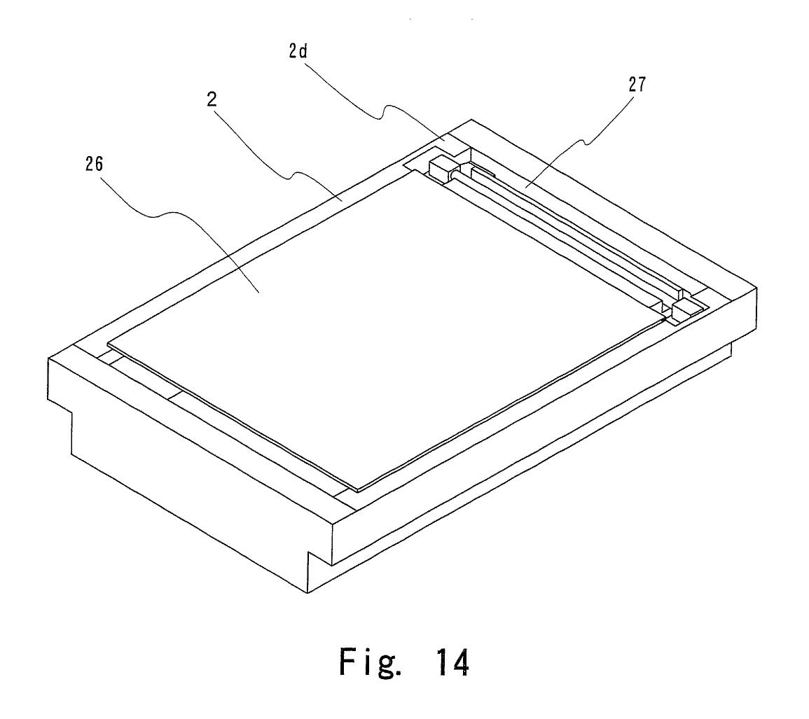

As illustrated in FIG. 14, a platen glass 26 is placed and attached onto the upper surface of the casing 2 of the image processor 1. A ceiling plate 2d of the casing 2 is provided with a replacement opening 27 adjacent to the platen glass 26. The full rate carriage 10 can be moved to a position, which faces the replacement opening 27. The width of the replacement opening 27 is greater than that of the platen glass 26, whereby the entire full rate carriage 10 can be exposed therethrough. Preferably, a stopper, or the like, is provided for preventing the full rate carriage 10 from moving to the position which faces the replacement opening 27 in a normal scanning operation, wherein the stopper can be removed to allow the full rate carriage 10 to move to such a position for replacement of the fluorescent lamp 11. The movement of the full rate carriage 10 to the position, which faces the replacement opening 27, can be performed manually. Preferably, a lid is provided for the replacement opening 27 so that the replacement opening 27 can be closed by the lid during normal operations.

The operation of the image processor according to the embodiment of the present invention having such a structure will now be described.

In order to mount the fluorescent lamp 11 onto the full rate carriage 10, the holding tongue pieces 19 of each lamp bracket 16 are slid into the holding grooves 17a of each socket 17 of the fluorescent lamp 11 along the longitudinal direction of the fluorescent lamp 11, thus completing the attachment of the lamp brackets 16 to the fluorescent lamp 11. Then, the fluorescent lamp 11 is placed onto the full rate carriage 10 from above by inserting and engaging the upper tongue piece 21a into the upper slit 15a and the lower tongue piece 21b and the flexible tongue piece 22 into the lower opening 15b. As a result of the placement, an upper edge portion of the front wall 15 is inserted between the upper tongue piece 21a and the front plate 16c, while a lower edge portion of the lower opening 15b is inserted between the lower tongue piece 21b and the front plate 16c. During the insertion of the lamp brackets 16, the flexible tongue piece 22 is suitably bent inwardly as the inclined surface 22a is pressed against the front wall 15. As the flexible tongue piece 22 reaches the lower opening 15b, the flexible tongue piece 22 restores from its bent position to its original position, and an upper edge portion of the flexible tongue piece 22 is engaged with an upper edge portion of the lower opening 15b. This prevents the lamp brackets 16 from easily coming off the full rate carriage 10. Then, the connector 18 can be connected to a predetermined position so as to connect the fluorescent lamp 11 to the inverter, after which the fluorescent lamp 11 is ready for being lit up.

The fluorescent lamp 11 can be replaced with a new fluorescent lamp as follows. In a case where the movement of the full rate carriage 10 is limited by means of the stopper, or the like, the stopper, or the like, is removed to move the full rate carriage 10 to a position which faces and is aligned with the replacement opening 27. At this position where the full rate carriage 10 and the fluorescent lamp 11 are exposed through the replacement opening 27, the connector 18 is disconnected from the predetermined position so as to disconnect the fluorescent lamp 11 from the inverter. Then, the flexible tongue piece 22 is pressed and bent inwardly so as to release the engagement between the upper edge portion of the flexible tongue piece 22 and the upper edge portion of the lower opening 15b, whereby the fluorescent lamp 11 together with the lamp brackets 16 can be pulled up from the full rate carriage 10. Then, each lamp bracket 16 can be detached from the fluorescent lamp 11 by sliding the lamp bracket 16 along the longitudinal direction of the fluorescent lamp 11 which has been detached from the full rate carriage 10. The detached lamp brackets 16 are then attached to a new fluorescent lamp 11, and the lamp brackets 16 along with the fluorescent lamp 11 are attached to the full rate carriage 10 from above in a manner as described above, thereby attaching the new fluorescent lamp 11 to the full rate carriage 10. After the connector 18 is connected to the predetermined position, the full rate carriage 10 with the new fluorescent lamp 11 mounted thereon is moved from the position which faces the replacement opening 27 to another position within the scanning area. Then, the moving range of the full rate carriage 10 is limited by means of the stopper, or the like, so as to prevent the full rate carriage 10 from moving to the position of the replacement opening 27.

In the present embodiment, the replacement opening 27 is provided so that the full rate carriage 10 can be moved to the position, which faces the replacement opening 27 for the replacement of the fluorescent lamp 11. An alternative structure may not have the replacement opening 27. In such a structure, the platen glass 26 can be removed from the casing 2 for the replacement of the fluorescent lamp 11. Although it requires the process of removing the platen glass 26, the replacement process as a whole is convenient because the fluorescent lamp 11 can be easily attached to and detached from the full rate carriage 10. Moreover, since the process can be performed within the casing 2, one can employ a structure where the fluorescent lamp 11 can be pulled out from the full rate carriage 10 in a somewhat inclined direction, rather than the vertical upward direction.

As described above, in the image processor according to the present invention, a light source lamp is attached to lamp brackets, and the lamp brackets can be attached to and detached from a carriage. Therefore, the light source lamp can be detached from the carriage by detaching the lamp brackets from the carriage without having to disconnecting the carriage from wires. Thus, the replacement of the light source lamp with a new light source lamp is made convenient. Moreover, it is not necessary to disconnect the carriage from the wires, thereby eliminating the need for the positional adjustment of the carriage with respect to the wires. Thus, the replacement process is made even more convenient.

The carriage can be moved to a replacement position which is beyond the moving range required for scanning an original, and the light source lamp can be replaced with a new light source lamp via a replacement opening which faces the replacement position, thereby eliminating the need for removing the platen glass. Thus, the replacement of the light source lamp with a new light source lamp is made even more convenient.

The lamp brackets can be attached to and detached from the carriage by an operation from above, thereby minimizing the space required for the attachment/detachment of the lamp brackets and the light source lamp. Therefore, particularly in a case where the replacement opening is provided, it is possible to minimize the size of the replacement opening.

The attachment/detachment of the connector for the light source lamp can be performed by an operation from above. Thus, the replacement of the light source lamp with a new light source lamp is made even more convenient.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. An image processor for obtaining image information of an original by scanning the original while successively changing a position of illumination by moving a light source lamp mounted on a carriage with respect to the original, said image processor including a casing for said carriage and a lamp bracket detachably attached to said carriage, and wherein said light source lamp is detachably attached to said lamp bracket.

2. The image processor according to claim 1, wherein:
the carriage can be moved to a replacement position which is beyond a range required for scanning the original;
a replacement opening is provided in a portion of the casing which faces the replacement position; and
the lamp bracket can be attached to and detached from the carriage via the replacement opening.

3. The image processor according to claim 2, wherein the lamp brackets can be attached to and detached from the carriage by an operation from above the carriage.

4. The image processor according to claim 1, wherein the lamp brackets can be attached to and detached from the carriage by an operation from above the carriage.

5. The image processor according to any one of claims 1 and further including a cab le connected to the light source lamp and the attachment and detachment of a connector for the cable can be performed by an operation from above the carriage.

6. The image processor according to any one of claims 2 and further including a cable connected to the light source lamp and the attachment and detachment of a connector for the cable can be performed by an operation from above the carriage.

7. The image processor according to any one of claims 3 and further including a cable connected to the light source lamp and the attachment and detachment of a connector for the cable can be performed by an operation from above the carriage.
